(19) United States
(12) Patent Application Publication
(10) Pub. No.: US 2023/0342625 A1
(43) Pub. Date: Oct. 26, 2023

(54) SYSTEM AND METHOD FOR AUGMENTING POPULATION OF SOLUTIONS

(71) Applicant: Cognizant Technology Solutions US Corp., Teaneck, NJ (US)

(72) Inventors: Hormoz Shahrzad, Dublin, CA (US); Risto Miikkulainen, Stanford, CA (US)

(21) Appl. No.: 17/727,953

(22) Filed: Apr. 25, 2022

(51) Int. Cl. G06N 3/12; G06Q 10/04; G06N 5/00

(52) U.S. Cl. CPC G06N 3/126; G06Q 10/04; G06N 5/003

(57) ABSTRACT

The present invention provides a system and a method for augmenting population of candidate solutions with respect to segments of one or more best solution(s) of the population to improve evolutionary computing. In operation, a segment is randomly selected from one of the one or more best solutions of a population. Further, a first population of solutions is generated with respect to randomly selected segment. Furthermore, a second population of candidate solutions is generated with respect to complement of the randomly selected segment. Yet further, the steps of randomly selecting a segment, and generating a first and a second population of solutions is repeated for other of the one or more best solutions of the population. Yet further, the first and the second population of candidate solutions generated with respect to respective one or more best solutions of the population are merged with the population to generate an augmented population.

### FIELD OF THE INVENTION

The present invention relates generally to the field of evolutionary computing. More particularly, the present invention relates to a system and a method for augmenting population of candidate solutions with respect to best solution of the population, whereby the search for a final optimal solution is focused around the best solution, thereby improving performance of evolutionary computation.

### BACKGROUND OF THE INVENTION

Evolutionary Computation is a field of optimization theory and is used extensively for solving complex optimization problems and for continuous optimization. Typically, evolutionary computation techniques are stochastic algorithms constituting heuristic search methods that model some natural phenomena, such as inheritance from previous successful generation of solutions, and natural selection where the best solutions pass their traits on to the successive generations to ‘evolve’ good solutions in order to solve complex optimization problem. A typical application of evolutionary computation includes randomly generating an initial population of solutions in relation to the optimization problem; evaluating fitness value of each solution out of the initial population of solutions; selecting fit solutions and best solution based on the fitness value; generating a new generation of population using genetic operators, such as recombination, crossover, and mutation; and repeating the steps of evaluating, selecting and generating next generation of population until convergence criteria is met.

However, in any application of evolutionary computation, convergence speed measured by the number of candidate solutions that need to be evaluated in the search space before the final best solution(s) is found, is one of the major concerns. In particular, lesser the number of candidates evaluated before convergence, higher the convergence speed. Further, more the number of candidates that are to be evaluated before convergence, lesser will be convergence speed. While a brute-force random search method involving a broad global search in the search space can get to the solution eventually, the convergence speed is low, as at least half of the possible candidate solutions are evaluated before convergence. Therefore, the time required to get to the solution is extensively high in a brute-force search. On the other hand, a narrow directed local search lacks consistency and leads to a premature convergence that provides sub-optimal solution(s).

In order to overcome the above described problems, various different techniques have been explored that combine or balance global and local search. However, each of the said techniques have their own limitations, and therefore, their applicability varies from domain to domain. For instance, some of the techniques combining or balancing global and local search have dependencies or assumption about the fitness landscape and relationship between some specific representation and the fitness. As a result, these methods are very effective in some domains while having lesser than the baseline performance in the other domains.

In light of the above drawbacks, there is a need for a system and a method for improving evolutionary computation. There is a need for a system and a method that can augment a population of solutions based on best candidate solution associated with the population. In particular, there is a need for a system and a method which provides for evolution of a population of solutions with respect to different segments of the best solution representation i.e. the genotype, whereby the search for the final optimal solution is focused around the best candidate solution. Further, there is a need for a system and a method that can direct the evolution of a population towards solutions generated more locally around the best candidate(s) of the population without interfering with general direction of evolution, thereby providing the best of global search and local search. Furthermore, there is a need for a system and a method which increases convergence speed. Yet further, there is a need for a system and a method which maximizes success rate of finding the optimal solution i.e. the final best solution. Yet further, there is a need for a system and a method which solves complex optimization problems effectively and efficiently in a relatively reduced amount of time or computations. Yet, further, there is need for a system and a method which can be easily integrated with any evolutionary computing algorithms.

### SUMMARY OF THE INVENTION

In accordance with various embodiments of the present invention, a method for augmenting a population of candidate solutions including one or more best solutions is provided. The method is implemented by a processor executing program instructions stored in a memory. The method comprising randomly selecting a segment from one of the one or more best solutions of the population of candidate solutions. The method further comprises generating a first population of candidate solutions with respect to the randomly selected segment of the one of the one or more best solutions. Further, the method comprises generating a second population of candidate solutions with respect to a complement of the randomly selected segment of the one of the one or more best solutions. Yet further, the method comprises repeating the steps of randomly selecting a segment, generating a first population and generating a second population for remaining of the one or more best solutions of the population until the first population and the second population of candidate solutions have been generated with respect to each of the remaining of the one or more best solutions. Yet further, the method comprises generating an augmented population by merging the population of candidate solutions with the first population and the second population of candidate solutions generated with respect to respective one or more best solutions.

In accordance with various embodiments of the present invention, a system for augmenting a population of candidate solutions including one or more best solutions is provided. The system comprises a memory storing program instructions, a processor configured to execute program instructions stored in the memory, and an augmentation engine executed by the processor. The system configured to randomly select a segment from one of the one or more best solutions of the population of candidate solutions. Further, the system is configured to generate a first population of candidate solutions with respect to the randomly selected segment of the one of the one or more best solutions. Furthermore, the system is configured to generate a second population of candidate solutions with respect to a complement of the randomly selected segment of the one of the one or more best solutions. Yet further, the system is configured to repeat the steps of randomly selecting a segment, generating a first population, and generating a second population for remaining of the one or more best solutions of the population until the first population and the second population of candidate solutions have been generated with respect to each of the remaining of the one or more best solutions. Yet further, the system is configured to generate an augmented population by merging the population of candidate solutions with the first population and the second population of candidate solutions generated with respect to respective one or more best solutions.

In accordance with various embodiments of the present invention, a computer program product is provided. The computer program product comprises a non-transitory computer-readable medium having computer-readable program code stored thereon, the computer-readable program code comprising instructions that, when executed by a processor, cause the processor to randomly select a segment from one of the one or more best solutions of the population of candidate solutions. Further, a first population of candidate solutions is generated with respect to the randomly selected segment of the one of the one or more best solutions. Yet further, a second population of candidate solutions is generated with respect to a complement of the randomly selected segment of the one of the one or more best solutions. Yet further, the steps of randomly selecting a segment, generating a first population, and generating a second population are repeated for remaining of the one or more best solutions of the population until the first population and the second population of candidate solutions have been generated with respect to each of the remaining of the one or more best solutions. Yet further, an augmented population is generated by merging the population of candidate solutions with the first population and the second population of candidate solutions generated with respect to respective one or more best solutions.

### BRIEF DESCRIPTION OF THE ACCOMPANYING DRAWINGS

The present invention is described by way of embodiments illustrated in the accompanying drawings wherein:

FIG. 1 is a block diagram of an environment including a system for augmenting a population of candidate solutions, in accordance with various embodiments of the present invention;

FIG. 2 is a flowchart illustrating a method for augmenting a population of candidate solutions, in accordance with various embodiments of the present invention;

FIG. 3 is a flowchart illustrating a method for improving evolutionary computation, in accordance with various embodiments of the present invention; and

FIG. 4 illustrates an exemplary computer system in which various embodiments of the present invention may be implemented.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention. The terms “best candidate solution” and “best solution” have been used interchangeably. The term “augmenting” as used in the specification refers to increasing the size of population or evolving the population with respect to the best solution of the population to enhance the population quality. The term “optimal solution” as used in the specification refers to the final best solution for the optimization problem. The term “seed population” as used in the specification refers to the initial population of solutions generated randomly in relation to the optimization problem. The term “fitness value” as used in the specification is indicative of the ability of the solution to solve the problem.

The present invention discloses a system and a method for augmenting a population of candidate solutions with respect to best solution of the population. In particular, the present invention provides for evolution of population of candidate solutions with respect to segments of one or more best candidate solution(s) of the population. In operation, a population of candidate solutions including one or more best solutions generated in relation to an optimization problem is received. Further, a segment is randomly selected from one of the one or more best solutions of the population. Furthermore, a first population of candidate solutions is generated by replacing a segment of each of the candidate solution of the received population excluding the one of the one or more best solutions with the randomly selected segment. Yet further, a second population of candidate solutions is generated by replacing a segment of each of the candidate solutions of the received population (excluding the one of the one or more best solutions) with a complement of the randomly selected segment. The complement of the randomly selected segment is the remaining segment of the one of the one or more best solutions after excluding the randomly selected segment. Yet further, the steps of randomly selecting a segment, and generating a first and a second population of solutions is repeated for other of the one or more best solutions of the received population. Yet further, the first and the second population of candidate solutions generated with respect to respective one or more best solutions are merged with the received population to generate an augmented population. Finally, the augmented population generated from the one or more best solutions is fed as an input to the evolutionary computing algorithms for evaluation, selection and evolution, and the process of augmentation, evaluation, selection and evolution is repeated until a convergence criterion is met.

The present invention would now be discussed in context of embodiments as illustrated in the accompanying drawings.

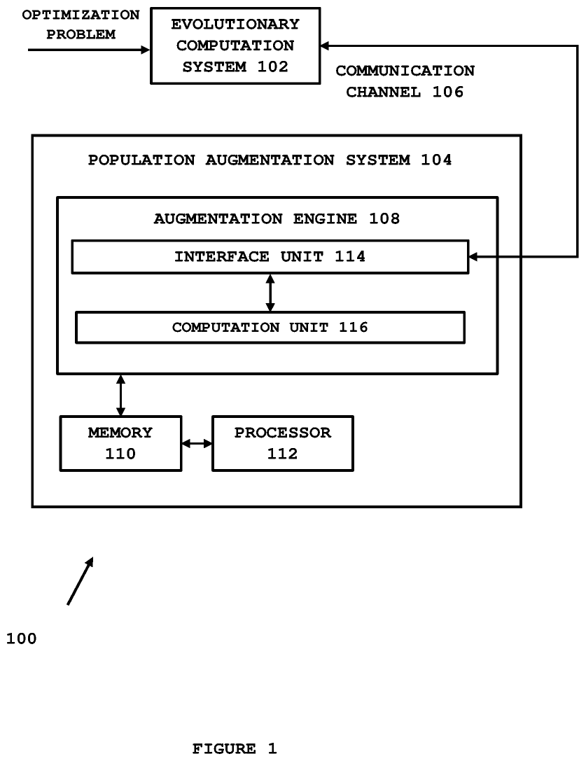

Referring to FIG. 1, a block diagram of an environment including a system for augmenting a population of candidate solutions is illustrated. In an embodiment of the present invention the environment 100 includes an evolutionary computation system 102, and a system for augmenting a population of candidate solutions, hereinafter referred to as population augmentation system 104.

In accordance with various embodiments of the present invention, the evolutionary computation system 102 is a software executable on a client-computing device (not shown) or a combination of software and hardware. In an embodiment of the present invention, the client-computing device may be a general purpose computer, such as a desktop, a laptop, a smartphone and a tablet; a super computer; a microcomputer or any device capable of executing instructions, connecting to a network and sending/receiving data. In accordance with various embodiments of the present invention, the evolutionary computation system 102 deploys or executes an Evolutionary Computing (EC) algorithm.

In accordance with various embodiments of the present invention, the evolutionary computation system 102 is configured to receive an optimization problem. Each optimization problem is associated with a set of conditions that must be satisfied to solve the optimization problem. In an embodiment of the present invention, the evolutionary computation system 102 is configured to randomly create a seed population of candidate solutions in a search-space in response to the received optimization problem. In another embodiment of the present invention, the seed population is fed into the evolutionary computation system 102. The population of candidate solutions may satisfy the conditions associated with the optimization problem to solve said problem with certain capability.

Further, the evolutionary computation system 102 is configured to evaluate each of the candidate solutions with a fitness function to determine fitness values of each of the solutions. The fitness value associated with a candidate solution is indicative of the ability of the solution to solve the problem. In accordance with various embodiments of the present invention, the evolutionary computation system 102 is configured to select candidate solutions, and also determine one or more best solutions of the population based on the fitness value. In accordance with various embodiment of the present invention, the evolutionary computation system 102 is also configured to generate a next generation of population of solutions based on the fitness values of the selected candidate solutions by applying operators inspired from natural evolution, such as crossover, mutation, and recombination to the selected solutions. In accordance with an embodiment of the present invention, the evolutionary computation system 102 is configured to interface with the population augmentation system 104 over a communication channel 106 to augment a population of solutions with respect to one or more best solutions of the population. Examples of the communication channel 106 may include, but are not limited to, an interface such as a software interface, a physical transmission medium such as a wire, or a logical connection over a multiplexed medium such as a radio channel in telecommunications and computer networking. Examples of radio channel in telecommunications and computer networking may include, but are not limited to, a Local Area Network (LAN), a Metropolitan Area Network (MAN), and a Wide Area Network (WAN). In accordance with various embodiments of the present invention, the evolutionary computation system 102 is configured to repeat the steps of evaluating, selecting and generating a new population until a termination criterion is met. Finally, the evolutionary computation system 102 is configured to select the optimal solution with the highest fitness value as the solution to the optimization problem.

In accordance with various embodiments of the present invention, the population augmentation system 104 is a software executable by a computing device or a combination of software and hardware. In an embodiment of the present invention, the population augmentation system 104 is a software configured for integration with the evolutionary computation system 102. In an exemplary embodiment of the present invention, the population augmentation system 104 is implemented as a plug-in for integration with the evolutionary computation system 102. In another embodiment of the present invention, the population augmentation system 104 is a software installable and executable by any client-computing device 104. In another embodiment of the present invention, as shown in FIG. 1, the population augmentation system 104 is a combination of a software and a hardware. In an embodiment of the present invention, the population augmentation system 104 may be implemented as a client-server architecture, wherein a client-computing device (not shown) and/or the evolutionary computation system 102 accesses a server hosting the population augmentation system 104 over the communication channel 106. In an exemplary embodiment of the present invention, the functionalities of the population augmentation system 104 are delivered as Software as a Service (SAAS) to one or more client-computing devices (not shown) and/or evolutionary computation system 102. In another embodiment of the present invention, the population augmentation system 104 may be implemented in a cloud computing architecture in which data, applications, services, and other resources are stored and delivered through shared data-centers. In an exemplary embodiment of the present invention, the population augmentation system 104 is a remote resource implemented over the cloud and accessible for shared usage in a distributed computing architecture by a plurality of evolutionary computation systems 102 and/or client-computing devices (not shown). In an exemplary embodiment of the present invention, the population augmentation system 104 may be accessed via an IP address/domain name. In another exemplary embodiment of the present invention, the population augmentation system 104 may be accessed via a user module of the population augmentation system 104 executable on the evolutionary computation system 102 and/or the client-computing device (not shown).

In an embodiment of the present invention, the population augmentation system 104 comprises an augmentation engine 108, a memory 110, and a processor 112. The augmentation engine 108 is operated via the processor 112 specifically programmed to execute instructions stored in the memory 110 for executing functionalities of the augmentation engine 108. In accordance with various embodiments of the present invention, the memory 110 is selected from a Random Access Memory (RAM), a Read-only memory (ROM), a hard drive disk (HDD) or any other memory capable of storing data and instructions.

In accordance with various embodiments of the present invention, the augmentation engine 108 is configured to receive complex data, such as population of solutions and one or more best solution(s) of the population, randomly selected segment from the best solution, and evolve each of the candidate solutions with respect to each of the one or more best solutions to generate an augmented population.

In accordance with various embodiments of the present invention, the augmentation engine 108 comprises an interface unit 114 and a computation unit 116. The various units of the augmentation engine 108 are operated via the processor 112 specifically programmed to execute instructions stored in the memory 110 for executing respective functionalities of the multiple units (114 and 116) in accordance with various embodiments of the present invention.

In accordance with various embodiments of the present invention, the interface unit 114 is configured to facilitate communication with the evolutionary computation system 102, an Input/output (I/O) device (not shown) associated with the population augmentation system 104, the client-computing device (not shown) and any external resource (not shown). Examples of the external resource may include, but are not limited to, storage devices, population repositories, and third party systems such as computing resources, databases etc. Examples of the I/O devices (not shown) may include, but are not limited to, keyboard, mouse, display, a touch screen display and any other device capable of receiving inputs and outputting results. In an embodiment of the present invention, the interface unit 114 is configured to provide communication with the evolutionary computation system 102 to receive population of solutions along with the one or more best solutions of the population. In an embodiment of the present invention, the interface unit 114 is configured to provide communication with the I/O device (not shown) associated with the population augmentation system 104 for updating system configurations, receiving population inputs, and receiving input from the system admins among other things.

In an embodiment of the present invention, the interface unit 114 is configured with any of the following: a web gateway, a mobile gateway, a Graphical User Interface (GUI), an integration interface, an administrator interface and a combination thereof to facilitate interfacing with the evolutionary computation system 102, the client-computing device (not shown), the I/O device (not shown) and any external resources (not shown). In an exemplary embodiment of the present invention, the integration interface is configured with one or more APIs, such as REST and SOAP APIs to facilitate smooth interfacing and/or integration with the evolutionary computation system 102, the client-computing device (not shown) and the external resources. In an embodiment of the present invention, the administrator interface provides communication with the Input/output device (not shown) for receiving, updating and modifying administration configurations from system admins, and receiving other data.

In an embodiment of the present invention, the GUI is accessible on the evolutionary computation system 102 and/or the client-computing device (not shown) to facilitate user interaction. In an exemplary embodiment of the present invention, the Graphical User Interface (GUI) allows a user to at least: select/receive a population of solutions, and select/receive one or more best solutions amongst other things. In an embodiment of the present invention, the graphical user interface (GUI) may be accessed from the evolutionary computation system 102 and/or the client-computing device (not shown) through a web gateway via a web browser. In another embodiment of the present invention, the GUI may be accessed by a mobile gateway using a user module installable on the evolutionary computation system 102 and/or client-computing device. In an embodiment of the present invention, where the population augmentation system 104 is a software installable and executable by any client-computing device (not shown), the GUI along with other units is locally accessible on the client-computing device (not shown).

In accordance with various embodiments of the present invention, the computation unit 116 is configured to receive a population of candidate solutions including one or more best solutions generated in relation to an optimization problem. In an embodiment of the present invention, the population of candidate solutions including the one or more best solutions is received from the evolutionary computation system 102. In an embodiment of the present invention, the received population of candidate solutions is a seed population, where the candidate solutions have been selected by a domain expert and each solution has some associated fitness value, and where the one or more best solutions are selected manually based on expertise of a domain expert. In a preferred embodiment of the present invention, the received population of candidate solutions is any population generated subsequent to the seed population, and the population of candidate solutions include one or more best solutions selected by the evolutionary computation system 102 based on fitness value of the solutions determined via evaluation. The one or more solutions having the highest fitness value are selected as the best solutions of the population.

In accordance with various embodiments of the present invention, the computation unit 116 is configured to randomly select a segment from each of the one or more best candidate solutions of the population. In accordance with various embodiments of the present invention, the randomly selected segment from respective one or more best solutions may not be continuous or contiguous. In an embodiment of the present invention, the computation unit 116 is configured to randomly select segments from each of the one or more best solutions of the population based on user inputs via the interface unit 114. In another embodiment of the present invention, the computation unit 116 is configured to randomly select segments from one or some of the one or more best solutions selected based on pareto-front technique. For instance, in case of a multi-objective optimization problem with more than one best solution, one or some of the best solutions out of the available one or more best solutions may be selected based on pareto-front technique.

In an example, it may be assumed that each candidate solution in the population is a binary array having 8 indices from 0 to 7, and each of the indices have a binary digit 0 or 1 as the element. Each solution in the form of binary array has different combinations of zeros and ones representing a candidate solution. It may be assumed that the combination of zeros and ones as shown below is the best solution of the population.

| | | | | | | | |
|---|---|---|---|---|---|---|---|
| 0 | 1 | 0 | 0 | 1 | 0 | 0 | 0 |
| 0 | 1 | 2 | 3 | 4 | 5 | 6 | 7 |

In accordance with the above example, the computation unit 116 is configured to randomly select indices of the subset of elements associated with the best solution of the population. In the above example, the elements of the selected indices together represent the randomly selected segment of the best solution, and the indices are representative of the address of the elements. For instance, the computation unit 116 may select indices 0 to 3, where indices 0, 1, 2, 3 represent address of the elements 0 1 0 0 representing a randomly selected segment of the best solution. The elements of indices 4 to 7 are representative of complement of the randomly selected segment. It is to be noted that the selection of indices from the best solution may not be contiguous. For instance, the computation unit 116 may select indices 1, 5 from in between of the array, where indices 1, 5 represent address of the elements 1 0 representative of a randomly selected segment of the best solution. The elements of indices 0, 2, 3, 4, 6, 7 are representative of complement of the randomly selected segment. Similarly, indices 2, 3, 7 or even 0, 2, 3, 4, 5, 6, 7 may be randomly selected, where the elements of the selected indices are representative of randomly selected segment of the best solution.

In another example, it may be assumed that the population has two best solutions (i.e. two solutions having same and high fitness value after evaluation) as shown below:

Best solution 1

| | | | | | | | |
|---|---|---|---|---|---|---|---|
| 0 | 1 | 0 | 0 | 1 | 0 | 0 | 0 |
| 0 | 1 | 2 | 3 | 4 | 5 | 6 | 7 |

Best solution 2

| | | | | | | | |
|---|---|---|---|---|---|---|---|
| 1 | 0 | 0 | 1 | 1 | 0 | 0 | 1 |
| 0 | 1 | 2 | 3 | 4 | 5 | 6 | 7 |

In accordance with the above example, the computation unit 116 is configured to randomly select indices of the subset of elements associated with the best solution 1 and best solution 2 of the population, respectively. In the example, the selected indices of best solution 1 are representative of the address of the elements of best solution 1, and the elements of the selected indices together represent the randomly selected segment of the best solution 1. Similarly, the selected indices of best solution 2 are representative of the address of the elements of best solution 2, and the elements of the selected indices together represent the randomly selected segment of the best solution 2. For instance, the computation unit 116 may select indices 3, 4, 6, 7 of best solution 1, where indices 3, 4, 6, 7 represent address of the elements 0 1 0 0 representing a randomly selected segment of the best solution 1. The elements of indices 0, 1, 2, 5 are representative of complement of the randomly selected segment of best solution 1. Similarly, the computation unit 116 may select indices 0 to 3 of best solution 2, where indices 0, 1, 2, 3 represent address of the elements 1 0 0 1 representing a randomly selected segment of the best solution 2. The elements of indices 4 to 7 are representative of complement of the randomly selected segment of best solution 2. It should be noted that the selection of indices from the best solution 1 and/or best solution 2 may not be contiguous.

In accordance with various embodiments of the present invention, the computation unit 116 is configured to generate a first population of candidate solutions with respect to randomly selected segment of one of the one or more best solutions. In an embodiment of the present invention, the computation unit 116 is configured to generate a first population by replacing a segment of each of the candidate solutions of the received population (excluding the one of the one or more best solutions) with the randomly selected segment of the one of the one or more best solutions. The one of the one or more best solutions is the best solution from which the segment is randomly selected. In another embodiment of the present invention, the computation unit 116 is configured to generate a first population by replacing a segment of each of the candidate solutions of the received population (excluding each of the one or more best solutions) with the randomly selected segment of the one of the one or more best solutions. In a preferred embodiment of the present invention, the position of segment of each of the candidate solutions that are replaced is same as the position of randomly selected segment in the best solution. In an example, where the best solution of the population is a binary array having 8 indices from 0 to 7, as shown below:

| | | | | | | | |
|---|---|---|---|---|---|---|---|
| 0 | 1 | 0 | 0 | 1 | 0 | 0 | 0 |
| 0 | 1 | 2 | 3 | 4 | 5 | 6 | 7 |

and indices 0 to 3 having elements 0 1 0 0 are randomly selected from the best solution, a new candidate solution is created from each of the candidate solutions of the received population (excluding the best solution) by replacing the elements of indices (0 to 3) of each of the candidate solutions with elements (0 1 0 0) of the best solution specified by the selected indices (0 to 3).

In accordance with various embodiments of the present invention, the computation unit 116 is configured to generate a second population of candidate solutions with respect to complement of the randomly selected segment of one of the one or more best solutions. In an embodiment of the present invention, the computation unit 116 is configured to generate a second population by replacing a segment of each of the candidate solutions of the received population (excluding the one of the one or more best solutions) with the complement of the randomly selected segment of the one of the one or more best solutions. The complement of the randomly selected segment of the best solution is the remaining segment of the best solution after excluding the randomly selected segment. In another embodiment of the present invention, the computation unit 116 is configured to generate a second population by replacing a segment of each of the candidate solutions of the received population (excluding each of the one or more best solutions of the population) with the complement of the randomly selected segment of the one of the one or more best solutions. In a preferred embodiment of the present invention, the position of segment of each of the candidate solutions that are replaced is same as the position of complement of the randomly selected segment in the best solution. In the example, where the best solution of the population is a binary array having 8 indices from 0 to 7, as shown below:

| | | | | | | | |
|---|---|---|---|---|---|---|---|
| 0 | 1 | 0 | 0 | 1 | 0 | 0 | 0 |
| 0 | 1 | 2 | 3 | 4 | 5 | 6 | 7 |

and indices 0 to 3 having elements 0 1 0 0 are representative of randomly selected segment of the best solution, the elements 1 0 0 0 of indices 4 to 7 are representative of complement of the randomly selected segment. A new candidate solution is created from each of the candidate solutions of the received population (excluding the best solution) by replacing the elements of indices (4 to 7) of each of the candidate solutions with elements 1 0 0 0 of the best solution specified by the indices 4 to 7 (which is complement of indices 0 to 3).

In accordance with various embodiments of the present invention, the computation unit 116 is configured to perform the steps of randomly selecting a segment, and generating a first and a second population of solutions with respect to each of the best solutions of the population. For example: in case of two best solutions as exemplified above, a segment is randomly selected for best solution 2, and the step of generating a first population with respect to the randomly selected segment of best solution 2 is performed simultaneously or subsequent to generating of first population with respect to the randomly selected segment of best solution 1. In the example, a first population with respect to best solution 2 is generated by replacing a segment of each of the candidate solutions of the received population (including best solution 1 and excluding best solution 2) with the randomly selected segment of the best solution 2. Similar, step is performed with respect to best solution 1. Further, the step of generating a second population with respect to complement of the randomly selected segment of best solution 2 is performed simultaneously or subsequent to generating of second population with respect to the complement of randomly selected segment of best solution 1. In the example, a second population with respect to best solution 2 is generated by replacing a segment of each of the candidate solutions of the received population (including best solution 1 and excluding best solution 2) with the complement of the randomly selected segment of the best solution 2. Similar, step is performed with respect to best solution 1. In accordance with another embodiment of the present invention, a first population with respect to best solution 1 is generated by replacing a segment of each of the candidate solutions of the received population (excluding best solution 1 and best solution 2) with the randomly selected segment of the best solution 1. A second population with respect to best solution 1 is generated by replacing a segment of each of the candidate solutions of the received population (excluding best solution 1 and best solution 2) with the complement of the randomly selected segment of the best solution 1. Similar, steps are performed with respect to best solution 2.

In another embodiment of the present invention, the computation unit 116 is configured to perform the steps of randomly selecting a segment, and generating a first population and a second population of solutions with respect to one or some of the one or more best solutions selected based on pareto-front technique.

In accordance with various embodiments of the present invention, the computation unit 116 is configured to generate an augmented population. In an embodiment of the present invention, the computation unit 116 is configured to generate an augmented population by merging the received population with the first and the second population of candidate solutions generated with respect to respective one or more best solutions.

In an embodiment of the present invention, the computation unit 116 is configured to feed the augmented population created with respect to one or more best solutions as an input to the evolutionary computing system 102 for evaluation, selection and evolution, and the process of augmentation, evaluation, selection and evolution is repeated for subsequent populations until a convergence criterion i.e. target condition is met.

Advantageously, the system of the present invention affords a technical effect in the field of evolutionary computing by enabling evolution of population of candidate solutions around different segments of one or more best solutions of the population. In particular, the system of the present invention affords search for the optimal solution i.e. the final best solution around the best solutions across one or more generations of populations, thereby improving performance of evolutionary computation. Further, the system of the present invention affords faster processing and significant time reduction in identification of the final best solution. Furthermore, the system of the present invention affords increased convergence speed, and maximizes success rate of finding the optimal solution i.e. the final best solution in the search space. Yet further, the system of the present invention provides ease of integration with any existing system deploying any evolutionary computing algorithm.

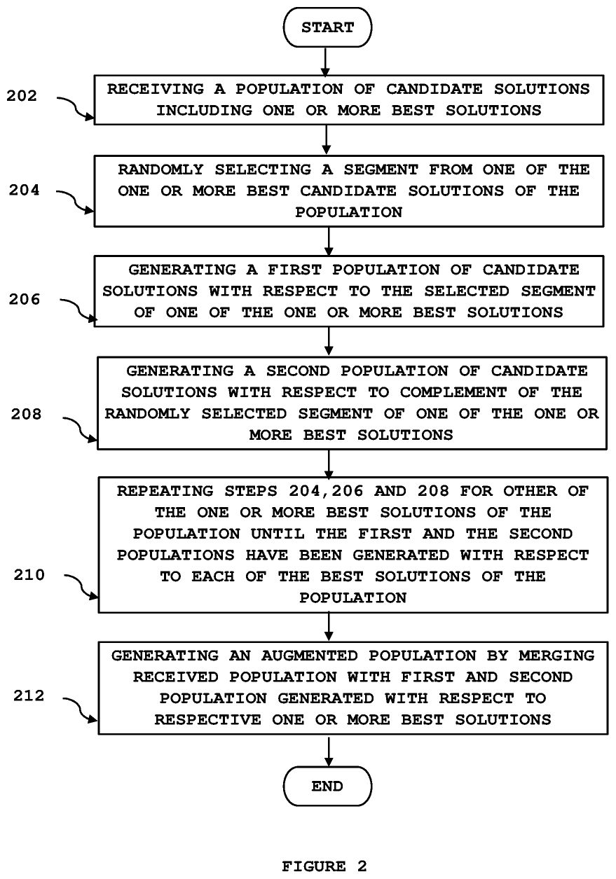

Referring to FIG. 2 a flowchart illustrating a method for augmenting a population of candidate solutions is shown, in accordance with various embodiments of the present invention.

At step 202, a population of candidate solutions including one or more best solutions generated in relation to an optimization problem is received. In an embodiment of the present invention, the population of candidate solutions including the one or more best solutions is received from an evolutionary computation system (102 of FIG. 1). In an embodiment of the present invention, the received population of candidate solutions is a seed population, where the candidate solutions have been selected by a domain expert and each solution has some associated fitness value, and where the one or more best solutions are selected manually based on expertise of the domain expert. In a preferred embodiment of the present invention, the population of candidate solutions is any population generated subsequent to the seed population, and the population of candidate solutions include one or more best solutions selected by the evolutionary computation system (102 of FIG. 1) based on evaluation of fitness value. The one or more solutions having the highest fitness value are selected as the best solutions of the population.

At step 204, a segment is randomly selected from one of the one or more best candidate solutions of the population. In accordance with various embodiments of the present invention, the randomly selected segment of any of the one or more best solutions may be contiguous/continuous or non-contiguous/non-contiguous. In operation, in an embodiment of the present invention, the one of the one or more best solutions for selection of segment is selected randomly or based on user inputs. In Further, the segment from the one of the one or more best solutions of the population is randomly selected. In an embodiment of the present invention, the segment from the one of the one or more best solutions is selected based on user inputs.

In an example, it is assumed that each candidate solution in the population is a binary array having 8 indices from 0 to 7, and each of the indices have a binary digit 0 or 1 as the element. Each solution in the form of binary array has different combinations of zeros and ones representing a candidate solution. It is assumed that the combination of zeros and ones as shown below is the best solution of the population.

| | | | | | | | |
|---|---|---|---|---|---|---|---|
| 0 | 1 | 0 | 0 | 1 | 0 | 0 | 0 |
| 0 | 1 | 2 | 3 | 4 | 5 | 6 | 7 |

In accordance with the above example, indices of the subset of elements associated with the best solution of the population are selected randomly. In the above example, the elements of the selected indices together represent a randomly selected segment of the best solution, and the indices are representative of the address of the elements. For instance, indices 0 to 3 may be randomly selected, where indices 0, 1, 2, 3 represent address of the elements 0 1 0 0 representing a randomly selected segment of the best solution. The elements of indices 4 to 7 are representative of complement of the randomly selected segment. It is to be noted that the selection of indices from the best solution may not be contiguous. For instance, indices 1, 5 may be selected from in between of the array, where indices 1, 5 represent address of the elements 1 0 representative of a randomly selected segment of the best solution. In this example, the elements of indices 0, 2, 3, 4, 6, 7 are representative of complement of the randomly selected segment. Similarly, indices 2, 3, 7 or even 0, 2, 3, 4, 5, 6, 7 may be selected randomly, where the elements of the selected indices are representative of randomly selected segments of the best solution.

In another example, let us assume that the population has two best solutions (i.e. two solutions having same and high fitness value after evaluation) as shown below:

Best solution 1

| | | | | | | | |
|---|---|---|---|---|---|---|---|
| 0 | 1 | 0 | 0 | 1 | 0 | 0 | 0 |
| 0 | 1 | 2 | 3 | 4 | 5 | 6 | 7 |

Best solution 2

| | | | | | | | |
|---|---|---|---|---|---|---|---|
| 1 | 0 | 0 | 1 | 1 | 0 | 0 | 1 |
| 0 | 1 | 2 | 3 | 4 | 5 | 6 | 7 |

In accordance with the above example, the indices of the subset of elements associated with each of the best solutions, i.e. the best solution 1 and best solution 2 of the population are selected randomly. In the example, the selected indices of best solution 1 are representative of the address of the elements of best solution 1, and the elements of the selected indices together represent the randomly selected segment of the best solution 1. Similarly, the selected indices of best solution 2 are representative of the address of the elements of best solution 2, and the elements of the selected indices together represent the randomly selected segment of the best solution 2. For instance, indices 3, 4, 6, 7 of best solution 1 may be selected, where indices 3, 4, 6, 7 represent address of the elements 0 1 0 0 representing a randomly selected segment of the best solution 1. The elements of indices 0, 1, 2, 5 are representative of complement of the randomly selected segment of best solution 1. Similarly, the computation unit 116 may select indices 0 to 3 of best solution 2, where indices 0, 1, 2, 3 represent address of the elements 1 0 0 1 representative of a randomly selected segment of the best solution 2. The elements of indices 4 to 7 are representative of complement of the randomly selected segment of best solution 2. It should be noted that the selection of indices from the best solution 1 and/or best solution 2 may not be contiguous.

At step 206, a first population of candidate solutions with respect to the randomly selected segment of one of the one or more best solutions is generated. In an embodiment of the present invention, a first population is generated by replacing a segment of each of the candidate solutions of the received population (excluding the one of the one or more best solutions) with the randomly selected segment of the one of the one or more best solutions. The one of the one or more best solutions is the best solution from which the randomly selected segment is selected. In another embodiment of the present invention, a first population is generated by replacing a segment of each of the candidate solutions of the received population (excluding each of the one or more best solutions) with the randomly selected segment of the one of the one or more best solutions. In a preferred embodiment of the present invention, the position of segment of each of the candidate solutions that are replaced is same as the position of randomly selected segment in the best solution. In the above example, where the best solution of the population is a binary array having 8 indices from 0 to 7, as shown below:

| | | | | | | | |
|---|---|---|---|---|---|---|---|
| 0 | 1 | 0 | 0 | 1 | 0 | 0 | 0 |
| 0 | 1 | 2 | 3 | 4 | 5 | 6 | 7 |

and indices 0 to 3 having elements 0 1 0 0 are selected from the best solution, a new candidate solution is created from each of the candidate solutions of the received population (excluding the best solution) by replacing the elements of indices (0 to 3) of each of the candidate solutions with elements (0 1 0 0) of the best solution specified by the selected indices (0 to 3).

At step 208, a second population of candidate solutions with respect to complement of the randomly selected segment of one of the one or more best solutions is generated. In an embodiment of the present invention, a second population is generated by replacing a segment of each of the candidate solutions of the received population (excluding the one of the one or more best solutions) with complement of the randomly selected segment of the one of the one or more best solutions. The complement of the randomly selected segment of the best solution is the remaining segment of the best solution after excluding the randomly selected segment. In another embodiment of the present invention, a second population is generated by replacing a segment of each of the candidate solutions of the received population (excluding each of the one or more best solutions of the population) with the complement of the randomly selected segment of the one of the one or more best solutions. In a preferred embodiment of the present invention, the position of segment of each of the candidate solutions that are replaced is same as the position of complement of the randomly selected segment in the best solution. In the example, where the best solution of the population is a binary array having 8 indices from 0 to 7, as shown below:

| | | | | | | | |
|---|---|---|---|---|---|---|---|
| 0 | 1 | 0 | 0 | 1 | 0 | 0 | 0 |
| 0 | 1 | 2 | 3 | 4 | 5 | 6 | 7 |

and indices 0 to 3 having elements 0 1 0 0, respectively are representative of randomly selected segment of the best solution, then the elements 1 0 0 0 of indices 4 to 7, respectively are representative of complement of the randomly selected segment. A new candidate solution is created from each of the candidate solutions of the received population (excluding the best solution) by replacing the elements of indices 4 to 7 of each of the candidate solutions with elements 1 0 0 0 of the best solution specified by the indices 4 to 7 (which is complement of indices 0 to 3).

At step 210, the steps 204, 206 and 208 are repeated for remaining of the one or more best solutions of the population until the first and the second populations have been generated with respect to each of the remaining best solutions of the population. In an embodiment of the present invention, the remaining of the one or more best solutions is indicative of all the remaining best solutions of the one or more best solutions. In another embodiment of the present invention, the remaining best solutions is indicative of best solutions selected out of the one or more best solutions based on pareto-front technique. In an example, where there are two best solutions, the step 204 is repeated for randomly selecting a segment from other best solution. Further, step 206 is repeated for generating a first population with respect to the randomly selected segment of the other of the one or more best solutions. Yet further, the step 208 is repeated for creating a second population with respect to complement of the randomly selected segment of the other of the one or more best solutions. It is to be understood, that there may be just one best solution in many instances, therefore the present invention is not limited to the number of best solutions. For instance, in case of a multi-objective optimization problem there may be more than one best solution, and one or a few of the best solutions may be selected based on pareto-front technique. Further there may be just one best solution for a single objective problem.

At step 212, an augmented population is generated. In an embodiment of the present invention, an augmented population is generated by merging the received population with the first and the second population of candidate solutions generated with respect to respective one or more best solutions.

In an embodiment of the present invention, the augmented population generated with respect to one or more best solutions is fed as an input to the evolutionary computing system (102 of FIG. 1) for evaluation, selection and evolution, and the process of augmentation, evaluation, selection and evolution is repeated until a convergence criterion is met.

Advantageously, the method of the present invention affords a technical effect in the field of evolutionary computing by enabling evolution of population of candidate solutions around different segments of one or more best solutions of the population. In particular, the method of the present invention enables search for the optimal solution i.e. the final best solution around the best solutions across one or more generations of populations, thereby improving performance of evolutionary computation. Further, the method of the present invention affords faster processing and significant time reduction in identification of the final best solution. Furthermore, the method of the present invention affords increased convergence speed, and maximizes success rate of finding the optimal solution i.e. the final best solution in the search space. Yet, further, the method of the present invention provides ease of integration with any existing system deploying any evolutionary computing algorithm.

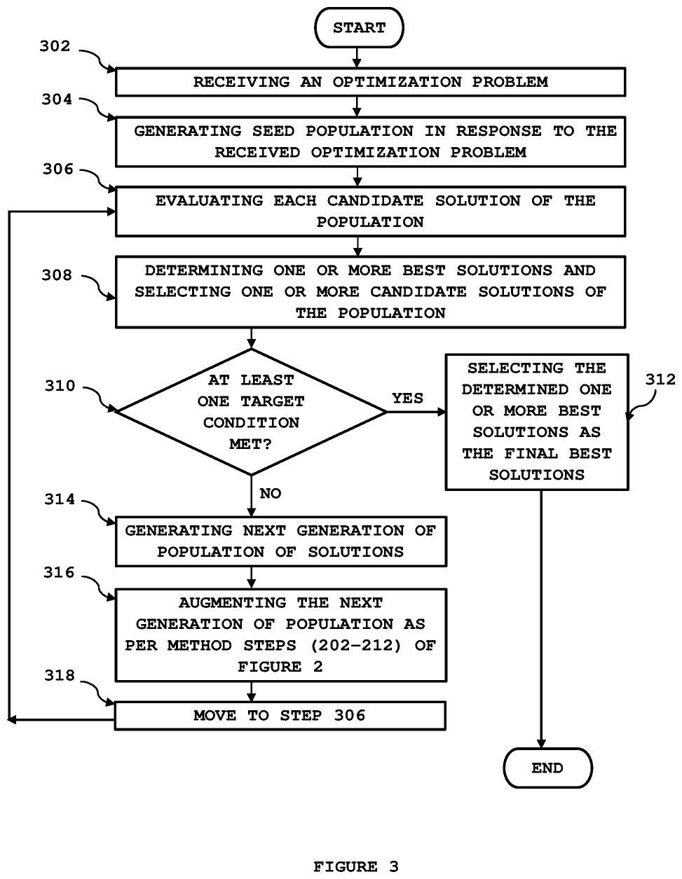

Referring to FIG. 3 a flowchart illustrating a method for improving evolutionary computation is shown, in accordance with various embodiments of the present invention.

At step 302, an optimization problem is received. In an embodiment of the present invention, an optimization problem is received from a client-computing device by an evolutionary computation system (102 of FIG. 1) executing evolutionary computation algorithm. In an embodiment of the present invention, each optimization problem is associated with a set of conditions that must be satisfied to solve the optimization problem.

At step 304, a seed population is generated in response to the received optimization problem. In an embodiment of the present invention, a seed population of candidate solutions is generated by the evolutionary computation system in a search-space in response to the received optimization problem. In another embodiment of the present invention, the seed population may be generated externally and fed into the evolutionary computation system. The population of candidate solutions may satisfy the conditions associated with the optimization problem to solve said problem with certain capability.

At step 306, each candidate solution of the population is evaluated. In an embodiment of the present invention, each of the candidate solutions of the population are evaluated with a fitness function. In an embodiment of the present invention, each of the candidate solutions of the seed population are evaluated with a fitness function using a privately hosted data to determine a fitness value of each of the solutions. The fitness value associated with a candidate solution is indicative of the ability of the solution to solve the problem.

At step 308, one or more best solutions of the population are determined and one or more candidate solutions are selected. In an embodiment of the present invention, one or more best solutions of the population are determined and one or more candidate solutions are selected based on the evaluated fitness value of each of the solutions of the population. In an embodiment of the present invention, the one or more candidate solutions having fitness value near to the fitness value of one or more best solutions are selected.

At step 310, a check is performed to determine if one of the target conditions from a set of target conditions has been achieved. In an exemplary embodiment of the present invention, the set target of conditions is representative of the stop criteria. In an embodiment of the present invention, the set of target conditions include, but are not limited to, achieving solution with a particular fitness value, max-iterations for evaluation etc.

At step 312, the determined one or more best solutions are selected as the final best solutions on determining that at least one of the target conditions has been achieved. In an exemplary embodiment of the present invention, the one or more solutions with the highest fitness value in the last updated population of solutions are selected as final best solutions.

At step 314, a next generation of population of solutions is generated on determining that none of the target conditions have been achieved. In an embodiment of the present invention, a next generation of population of solutions (i.e. an evolved population) is generated based on the determined one or more best solutions and the selected one or more candidate solutions. In an embodiment of the present invention, the next generation of population of solutions is generated based on the fitness values of the selected candidate solutions and the one or more best solutions by applying operators selected from, but not limited to, crossover, mutation, and recombination.

At step 316, the next generation of population is augmented as per the method steps (202-212) of FIG. 2. In an embodiment of the present invention, the next generation of population is augmented with respect to the one or more best solutions of said next generation of population. It is to be understood that since the evolution style at step 314 is “elitism” i.e. keeping the best or elite solutions and moving them to the next generation of population, therefore, the one or more best solutions determined at step 308 for the population generated at step 304 (i.e. the previous population) are also the best solutions for the next generation of population generated at step 314.

At step 318, step 306 to 316 are repeated until one of the target conditions is achieved.

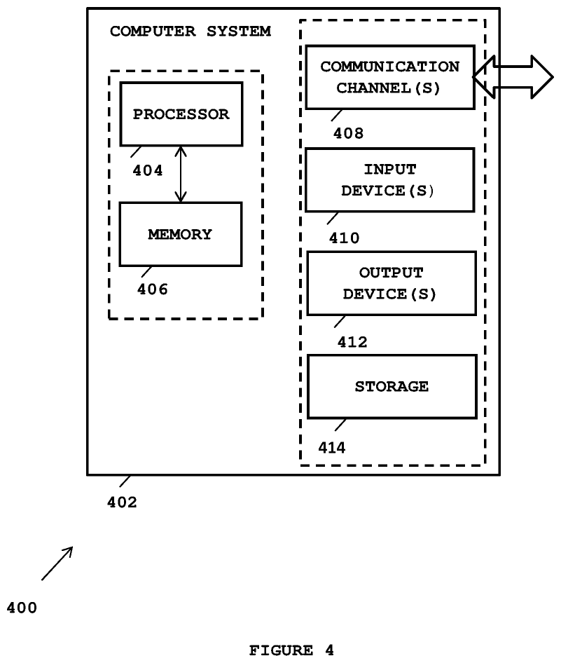

Referring to FIG. 4 an exemplary computer system in which various embodiments of the present invention may be implemented is illustrated. The computer system 402 comprises a processor 404 and a memory 406. The processor 404 executes program instructions and is a real processor. The computer system 402 is not intended to suggest any limitation as to scope of use or functionality of described embodiments. For example, the computer system 402 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 406 may store software for implementing various embodiments of the present invention. The computer system 402 may have additional components. For example, the computer system 402 includes one or more communication channels 408, one or more input devices 410, one or more output devices 412, and storage 414. An interconnection mechanism (not shown) such as a bus, controller, or network, interconnects the components of the computer system 402. In various embodiments of the present invention, operating system software (not shown) provides an operating environment for various softwares executing in the computer system 402, and manages different functionalities of the components of the computer system 402.

The communication channel(s) 408 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 410 may include, but not limited to, a keyboard, mouse, pen, joystick, trackball, a voice device, a scanning device, touch screen or any another device that is capable of providing input to the computer system 402. In an embodiment of the present invention, the input device(s) 410 may be a sound card or similar device that accepts audio input in analog or digital form. The output device(s) 412 may include, but not limited to, a user interface on CRT or LCD, printer, speaker, CD/DVD writer, or any other device that provides output from the computer system 402.

The storage 414 may include, but not limited to, magnetic disks, magnetic tapes, CD-ROMs, CD-RWs, DVDs, flash drives or any other medium which can be used to store information and can be accessed by the computer system 402. In various embodiments of the present invention, the storage 414 contains program instructions for implementing the described embodiments.

The present invention may suitably be embodied as a computer program product for use with the computer system 402. The method described herein is typically implemented as a computer program product, comprising a set of program instructions which is executed by the computer system 402 or any other similar device. The set of program instructions may be a series of computer readable codes stored on a tangible medium, such as a computer readable storage medium (storage 414), for example, diskette, CD-ROM, ROM, flash drives or hard disk, or transmittable to the computer system 402, via a modem or other interface device, over either a tangible medium, including but not limited to optical or analogue communications channel(s) 408. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

We claim:

1. A method for augmenting a population of candidate solutions including one or more best solutions, wherein the method is implemented by a processor executing program instructions stored in a memory, the method comprising:
a. randomly selecting, by the processor, a segment from one of the one or more best solutions of the population of candidate solutions;
b. generating, by the processor, a first population of candidate solutions with respect to the randomly selected segment of the one of the one or more best solutions;
c. generating, by the processor, a second population of candidate solutions with respect to a complement of the randomly selected segment of the one of the one or more best solutions; and
d. repeating, by the processor, steps a, b and c for remaining of the one or more best solutions of the population until the first population and the second population of candidate solutions have been generated with respect to each of the remaining of the one or more best solutions; and
e. generating, by the processor, an augmented population by merging the population of candidate solutions with the first population and the second population of candidate solutions generated with respect to respective one or more best solutions.

2. The method as claimed in claim 1, wherein the population of candidate solutions including the one or more best solutions is any population generated in relation to an optimization problem subsequent to a seed population, further wherein the one or more best solutions are solutions of the population having highest fitness value to solve the optimization problem.

3. The method as claimed in claim 1, wherein the randomly selected segment is contiguous or non-contiguous.

4. The method as claimed in claim 1, wherein the one of the one or more best solutions is selected randomly or based on user inputs for random selection of segment.

5. The method as claimed in claim 1, wherein generating the first population of candidate solutions with respect to the randomly selected segment of the one of the one or more best solutions comprises:
replacing a segment of each of the candidate solutions of the population excluding the one of the one or more best solutions with the randomly selected segment; or
replacing the segment of each of the candidate solutions of the population excluding each of the one or more best solutions with the randomly selected segment of the one of the one or more best solutions.

6. The method as claimed in claim 5, wherein position of the segment of each of the candidate solutions that is replaced is same as the position of the randomly selected segment in the one of the one or more best solutions.

7. The method as claimed in claim 1, wherein generating the second population of candidate solutions with respect to the complement of the randomly selected segment of the one of the one or more best solutions comprises:
replacing a segment of each of the candidate solutions of the population excluding the one of the one or more best solutions with the complement of the randomly selected segment of the one of the one or more best solutions; or
replacing the segment of each of the candidate solutions of the population excluding each of the one or more best solutions of the population with the complement of the randomly selected segment of the one of the one or more best solutions.

8. The method as claimed in claim 7, wherein position of the segment of each of the candidate solutions that is replaced is same as position of the complement of the randomly selected segment in the one of the one or more best solutions.

9. The method as claimed in claim 1, wherein said method is used with evolutionary computing algorithms subsequent to each step of evaluation of candidate solutions of respective populations until one target condition from a set of target conditions is achieved, said respective populations generated subsequent to a seed population.

10. A system for augmenting a population of candidate solutions including one or more best solutions, the system comprising:
a memory storing program instructions; a processor configured to execute program instructions stored in the memory; and an augmentation engine executed by the processor, and configured to:
a. randomly select a segment from one of the one or more best solutions of the population of candidate solutions;
b. generate a first population of candidate solutions with respect to the randomly selected segment of the one of the one or more best solutions;
c. generate a second population of candidate solutions with respect to a complement of the randomly selected segment of the one of the one or more best solutions; and
d. repeat steps a, b and c for remaining of the one or more best solutions of the population until the first population and the second population of candidate solutions have been generated with respect to each of the remaining of the one or more best solutions; and
e. generate an augmented population by merging the population of candidate solutions with the first population and the second population of candidate solutions generated with respect to respective one or more best solutions.

11. The system as claimed in claim 10, wherein the augmentation engine comprises an interface unit executed by the processor, said interface unit configured to receive the population of candidate solutions including the one or more best solutions, wherein the population of candidate solutions is any population generated in relation to an optimization problem subsequent to a seed population, further wherein the one or more best solutions are solutions of the population having highest fitness value to solve the optimization problem.

12. The system as claimed in claim 10, wherein the randomly selected segment is contiguous or non-contiguous.

13. The system as claimed in claim 10, wherein the one of the one or more best solutions is selected randomly or based on user inputs for random selection of segment.

14. The system as claimed in claim 10, wherein generating the first population of candidate solutions with respect to the randomly selected segment of the one of the one or more best solutions comprises:
replacing a segment of each of the candidate solutions of the population excluding the one of the one or more best solutions with the randomly selected segment; or
replacing the segment of each of the candidate solutions of the population excluding each of the one or more best solutions with the randomly selected segment of the one of the one or more best solutions.

15. The system as claimed in claim 14, wherein position of the segment of each of the candidate solutions that is replaced is same as the position of the randomly selected segment in the one of the one or more best solutions.

16. The system as claimed in claim 10, wherein generating the second population of candidate solutions with respect to the complement of the randomly selected segment of the one of the one or more best solutions comprises:
replacing a segment of each of the candidate solutions of the population excluding the one of the one or more best solutions with the complement of the randomly selected segment of the one of the one or more best solutions; or
replacing the segment of each of the candidate solutions of the population excluding each of the one or more best solutions of the population with the complement of the randomly selected segment of the one of the one or more best solutions.

17. The system as claimed in claim 16, wherein position of the segment of each of the candidate solutions that is replaced is same as position of the complement of the randomly selected segment in the one of the one or more best solutions.

18. The system as claimed in claim 10, wherein said system interfaces with an evolutionary computation system executing an Evolutionary Computing (EC) algorithm, said system configured to provide augmentation of any population of candidate solutions including one or more best solutions.

19. A computer program product comprising:
a non-transitory computer-readable medium having computer-readable program code stored thereon, the computer-readable program code comprising instructions that, when executed by a processor, cause the processor to:
a. randomly select a segment from one of the one or more best solutions of the population of candidate solutions;
b. generate a first population of candidate solutions with respect to the randomly selected segment of the one of the one or more best solutions;
c. generate a second population of candidate solutions with respect to a complement of the randomly selected segment of the one of the one or more best solutions; and
d. repeat steps a, b and c for remaining of the one or more best solutions of the population until the first population and the second population of candidate solutions have been generated with respect to each of the remaining of the one or more best solutions; and
e. generate an augmented population by merging the population of candidate solutions with the first population and the second population of candidate solutions generated with respect to respective one or more best solutions.
